(19) United States
(12) Patent Application Publication
(10) Pub. No.: US 2004/0061813 A1
(43) Pub. Date: Apr. 1, 2004

(54) Backlight unit and liquid crystal display apparatus comprising the same

(76) Inventor: Kentaroh Aoki, Matsusaka-shi (JP)

Correspondence Address: BIRCH STEWART KOLASCH & BIRCH, PO BOX 747, FALLS CHURCH, VA, 22040-0747, US

(21) Appl. No.: 10/664,152

(22) Filed: Sep. 17, 2003

(30) Foreign Application Priority Data
Sep. 18, 2002 (JP) 2002-272308

(51) Int. Cl. G02F 1/1335

(52) U.S. Cl. 349/65

(57) ABSTRACT

A backlight unit is provided, which comprises a linear light source for generating a light source light, a light guide plate comprising an end side and a broad side, and a light amount reducing member for reducing the amount of the light source light. The light amount reducing member is capable of transmitting light and is made of a material having a greater attenuation coefficient than that of the light guide plate. The light source light is input to the end side, is propagated through the light guide plate, and is output through the broad side. The light amount reducing member is provided at a joint portion of the end side and the broad side and portions neighboring the joint portion of the light guide plate.

### BACKGROUND OF THE INVENTION

1. Field of the Invention

The present invention relates to a backlight unit for irradiating a liquid crystal or the like with light from the rear side thereof, and a liquid crystal display apparatus comprising the backlight unit.

2. Description of the Related Art

In general, a liquid crystal display apparatus comprises a liquid crystal panel comprising a pair of opposed substrates, between which a liquid crystal layer is sandwiched. In the liquid crystal display apparatus, a display voltage is applied to the liquid crystal layer by an electrode provided on each of the pair of opposed substrates. In the liquid crystal display apparatus, by changing the orientations of liquid crystal molecules within the liquid crystal layer, light incident to the liquid crystal layer is transmitted/blocked so as to display characters, graphics or the like on the display screen.

A backlight unit is provided at the rear side of the liquid crystal panel. The backlight unit comprises a light source and a light guide plate. Light is input from the light source to an end side of the light guide plate. The input light is propagated through the light guide plate and is output through a broader side (proximal to the liquid crystal panel) of the light guide plate. The backlight unit allows light output by the light guide plate to impinge on the liquid crystal panel.

Hereinafter, the configuration of a liquid crystal display apparatus comprising a conventional backlight unit will be described.

FIG. 7 shows the configuration of the major parts of a conventional liquid crystal display apparatus 200.

The liquid crystal display apparatus 200 comprises a liquid crystal panel 101 used as a screen display and a backlight unit 110 provided at the rear side of the liquid crystal panel 101. The backlight unit 110 irradiates the liquid crystal panel 101 with light.

The backlight unit 110 comprises a linear light source 111, a lamp reflector 112, a frame-like chassis 113 made of a resin, a reflection sheet 114, a light guide plate 115, a diffuse sheet 116, a condenser sheet 117, and a diffuse sheet 118 having a light blocking function.

The chassis 113 houses a plurality of members included in the backlight unit 110 and holds the liquid crystal panel 101. One end portion of the chassis 113 is folded into a “U” shape (or a squared C shape). The linear light source 111 is housed within the folded portion (a concave portion of the folded portion). The linear light source 111 is a fluorescent lamp elongating in a direction or an LED. The chassis 113 is provided with the lamp reflector 112. The lamp reflector 112 is provided in a manner to surround the linear light source 111. Both the chassis 113 and the lamp reflector 112 are in a “U” shape (or a squared C shape) so that the lamp reflector 112 has an opening through which light emitted by the linear light source 111 goes out.

The reflection sheet 114 and the light guide plate 115 are provided on the chassis 113. Optical sheets, such as the diffuse sheet 116, the condenser sheet 117, the diffuse sheet 118 having a light blocking function, and the like, are provided on the light guide plate 115. The light guide plate 115 is in the shape of a wedge, through one end side of which light is input from the linear light source 111 positioned along the width direction thereof. Light input through the end side of light guide plate 115 is propagated through the light guide plate 115 toward the other end side. In this case, light going toward the rear side of the light guide plate 115, on which the reflection sheet 114 is provided, is reflected by the reflection sheet 114 toward the front side of the light guide plate 115, on which the liquid crystal panel is provided, so that the light is emitted through the light guide plate 115. In order to emit light uniformly, a plurality of optical sheets (e.g., the diffuse sheet 116, the condenser sheet 117, and the diffuse sheet 118) are provided on the rear side of the liquid crystal panel 101. A lamp cover is attached to a predetermined portion of the chassis 113.

On the backlight unit 110, the liquid crystal panel 101 on which a circuit board and the like are mounted is provided. A metal frame 120 is provided to fix the liquid crystal panel 101 on a predetermined position of the chassis 113.

Recently, while some transmissive liquid crystal display apparatuses are made thinner and thinner and smaller and smaller, the size of the liquid crystal panel included in other transmissive liquid crystal display apparatuses is increasing. In the above-described transmissive liquid crystal display apparatus 200, characters, graphics, or the like are displayed by irradiating the liquid crystal panel 101 with light from the backlight unit 110 provided at the rear side of the liquid crystal panel 101. In order to increase the size of the liquid crystal panel, it is necessary to attach the liquid crystal panel 101 to the backlight unit 110 while keeping the display area of the liquid crystal panel 101 large. Therefore, the width or area of the surrounding portion (frame portion) of the liquid crystal panel 101 needs to be reduced (narrow the frame).

In a liquid crystal display apparatus comprising an edge light type backlight unit, a bright line occurs at the light source side of the liquid crystal panel 101, so that irregularity occurs in the luminance distribution of the liquid crystal panel 101. This is because, for example, a large amount of light is input to the light source side of the crystal panel 101, or light emitted by the light source 110 is directly input to the liquid crystal panel 101. Note that the edge light type backlight unit is a backlight unit in which a linear light source (e.g., a fluorescent lamp) is provided along an end side of a light guide plate.

When the frame of the liquid crystal display apparatus is narrowed, the distance between the liquid crystal panel 101 and the light source (e.g., a fluorescent lamp) is reduced. In this case, a liquid crystal display apparatus comprising an edge light type backlight unit is strongly affected by light emitted by the linear light source. In addition, the liquid crystal panel is adversely affected by electromagnetic noise generated by the linear light source (e.g., flicker in the screen). Electromagnetic noise is an example of ElectroMagnetic Interference (EMI).

Japanese Laid-Open Publication No. 62-169193 discloses a method of covering the surface of an incandescent lamp with an irradiation reducing means made of an Indium Tin Oxide (ITO) film so as to absorb infra-red light to reduce the influence of heat. In this method, however, 20% of the visible light emitted by the lamp is absorbed by the ITO film, resulting in a reduction in the utilization efficiency of light. Further, a thicker ITO film is more effective in the enhancement of the capability of the film to absorb electromagnetic noise. However, the thicker the ITO film, the lesser the transmittance of light.

Japanese Utility Model Laid-Open Publication No. 5-69733 and Japanese Laid-Open Publication No. 2002-148651 disclose a method of using a transparent conductive material to reduce an adverse influence of electromagnetic noise generated by a fluorescent lamp on a liquid crystal panel. In this method, however, the transparent conductive material covers the liquid crystal panel, so that 20% of light emitted by the light source is absorbed by the transparent conductive material, resulting in a reduction in the transmittance of light.

Further, Japanese Laid-Open Publication No. 11-142841, Japanese Laid-Open Publication No. 11-224517, and Japanese Laid-Open Publication No. 2001-126522 disclose a method of reducing the adverse influence of electromagnetic noise generated by a fluorescent lamp on a liquid crystal panel by providing a reflection sheet comprising a conductive film, a metal lamp reflector, or the like. However, the adverse influence of electromagnetic noise generated by a fluorescent lamp on a liquid crystal panel is not sufficiently reduced by the method.

### SUMMARY OF THE INVENTION

According to an aspect of the present invention, a backlight unit is provided, which comprises: a linear light source for generating a light source light; a light guide plate comprising an end side and a broad side; and a light amount reducing member for reducing the amount of the light source light, capable of transmitting light and made of a material having a greater attenuation coefficient than that of the light guide plate. The light source light is input to the end side, is propagated through the light guide plate, and is output through the broad side. The light amount reducing member is provided at a joint portion of the end side and the broad side and portions neighboring the joint portion of the light guide plate.

In one embodiment of this invention, the light amount reducing member is in the shape of an “L” extending from the end side to the broad side.

In one embodiment of this invention, the light amount reducing member is made of a conductive material.

In one embodiment of this invention, the light amount reducing member is connected to a ground.

According to another aspect of the present invention, a liquid crystal display apparatus is provided, which comprises a backlight unit comprising: a linear light source for generating a light source light; a light guide plate comprising an end side and a broad side; and a member for reducing the amount of the light source light, capable of transmitting light and made of a material having a greater attenuation coefficient than that of the light guide plate. The light source light is input to the end side, is propagated through the light guide plate, and is output through the broad side. The light amount reducing member is provided at a joint portion of the end side and the broad side and portions neighboring the joint portion of the light guide plate. The apparatus further comprises a liquid crystal panel provided on the broad side of the backlight unit, capable of performing liquid crystal display using the light source light of the backlight unit.

Hereinafter, functions of the present invention will be described.

When light is propagated through a medium, the behavior of the light is greatly affected by the refractive index (n) of the medium and the attenuation coefficient (k) of the medium. The relationship between a complex refractive index (N) and the refractive index (n) and attenuation coefficient (k) of the medium is represented by:

N=n−jk.

FIG. 6 shows an example of the behavior of light in a medium. As shown in the top and middle of FIG. 6, light travels slower in a medium having a refractive index (n) than in vacuum. As shown in the bottom of FIG. 6, the intensity of light traveling in a medium having a complex refractive index of (n−jk) is attenuated with an increase in the attenuation coefficient (k) of a medium. Therefore, a medium having a higher attenuation coefficient (k) can suppress the amount of light entering the medium to a greater extent.

Therefore, in the present invention, a light amount reducing member is provided at an end side portion of a light guide plate, which is proximal to a linear light source (specifically, a joint portion of the end side and a broader side and portions neighboring the joint portion). The light amount reducing member is capable of transmitting light and is made of a material having a great attenuation coefficient. Therefore, the amount of light which is emitted from the linear light source through the light guide plate to the liquid crystal panel is suppressed. As a result, the occurrence of a bright line at a side of the liquid crystal panel, which is proximal to the linear light source, can be reduced. The light amount reducing member extends in the shape of an “L” at the end side portion of the light guide plate, which is proximal to the linear light source. The size of the light amount reducing member can be adjusted depending on the level of the bright line. For example, the light amount reducing member extends from a light inputting portion at the end side portion of the light guide plate, which is proximal to the linear light source, to a light emitting portion at the broad side of the light guide plate, which is proximal to the liquid crystal panel, resulting in an “L” shape. As a result, the utilization efficiency of light is improved as compared to conventional techniques, such as covering a light source or a liquid crystal panel with an ITO film.

The light amount reducing member included in the backlight unit of the present invention may be made of a conductive material. By connecting the light amount reducing member of a conductive material to a ground, electromagnetic noise occurring at the linear light source (e.g., a fluorescent lamp) is absorbed by the light amount reducing member. As a result, an adverse influence of the electromagnetic noise on the liquid crystal panel can be reduced. The light amount reducing member is provided on a side of the light guide plate, which is proximal to the linear light source. Therefore, the adverse influence of the electromagnetic noise generated at the linear light source (e.g., a fluorescent lamp) on the liquid crystal panel can be prevented effectively as compared to conventional techniques using a reflection sheet comprising a conductive film, a metal lamp reflector, or the like.

For example, an ITO film which is a transparent conductive material is highly conductive because of its low resistance. By connecting a light amount reducing member made of an ITO film to a ground, electromagnetic noise generated at the linear light source (e.g., a fluorescent lamp) can be absorbed by the light amount reducing member. As a result, the adverse influence of electromagnetic noise on the liquid crystal panel can be reduced. Although the ITO film is transparent, the light transmittance of the ITO film is about 70% to 90% with respect to the visible light region. Therefore, the amount of light emitted from the linear light source through the light guide plate to the liquid crystal panel is reduced, thereby reducing the occurrence of a bright line at a side of the liquid crystal panel, which is proximal to the linear light source.

Thus, the invention described herein makes possible the advantages of providing a backlight unit which can reduce the occurrence of a bright line at a side of a liquid crystal panel, which is proximal to a linear light source and electromagnetic noise occurring at the linear light source, while effectively utilizing light emitted by the linear light source; and a liquid crystal display apparatus comprising the backlight unit.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram showing a configuration of a major portion of a liquid crystal display apparatus 100 according to an embodiment of the present invention.

FIG. 2 is a cross-sectional view showing one end portion of a backlight unit 10 of FIG. 1.

FIG. 3 is a perspective view showing the end side portion of the backlight unit 10 of FIG. 1.

FIG. 4 shows an exemplary development of a conductive sheet 23 of FIG. 3.

FIG. 5 is a diagram showing exemplary performances of a general ITO film formed by an in-line type sputtering apparatus.

FIG. 6 is a diagram showing an example of the behavior of light in a medium.

FIG. 7 is a diagram showing the configuration of a major part of a conventional liquid crystal display apparatus 200.

### DESCRIPTION OF THE PREFERRED EMBODIMENTS

Hereinafter, the present invention will be described by way of illustrative examples with reference to the accompanying drawings.

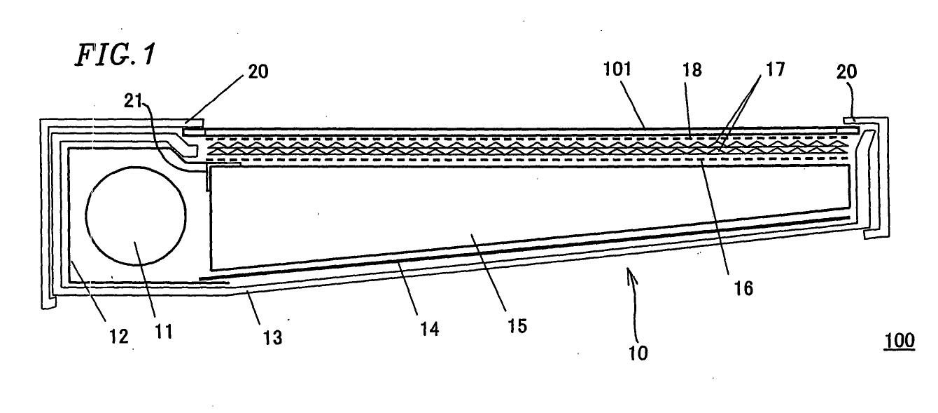

FIG. 1 shows a configuration of a major portion of a liquid crystal display apparatus 100 according to an embodiment of the present invention.

The liquid crystal display apparatus 100 comprises a liquid crystal panel 101 used as a display screen and a backlight unit 10 provided at the rear side of the liquid crystal panel 101. The backlight unit 10 irradiates the liquid crystal panel 101 with light.

The backlight unit 10 comprises a linear light source 11, a lamp reflector 12, a chassis 13, a reflection sheet 14, a light guide plate 15, a diffuse sheet 16, a condenser sheet 17, a diffuse sheet 18 having a light blocking function, and a light amount reducing member 21.

The chassis 13 is in the shape of a frame made of, for example, a resin. The chassis 13 houses the plurality of members included in the backlight unit 10 and holds the liquid crystal panel 101. One end portion of the chassis 13 is folded into a “U” shape (or a squared C shape). The linear light source 11 is housed within the folded portion (a concave portion of the folded portion). The linear light source 11 is a fluorescent lamp elongating in a direction or an LED. The lamp reflector 12 is provided between the folded portion of the chassis 13 and the linear light source 11. The lamp reflector 12 is also in a “U” shape (or a squared C shape) so that the lamp reflector 12 surrounds the linear light source 11. The lamp reflector 12 has an opening through which light emitted by the linear light source 11 goes out.

The reflection sheet 14 is provided on the chassis 13. The light guide plate 15 is provided on the reflection sheet 14. Further, optical sheets, such as the diffuse sheet 16, the condenser sheet 17, the diffuse sheet 18 having a light blocking function, and the like, are provided on the light guide plate 15 in this order.

The light amount reducing member 21 is provided on a corner portion of the light guide plate 15, which is proximal to the linear light source 11 (hereinafter referred to as the proximal corner portion of the light guide plate 15). The proximal corner portion of the light guide plate 15 includes: a boundary between an end side of the light guide plate 15, which is proximal to the linear light source 11, and an upper, broader side of the light guide plate 15, through which light is emitted; and portions neighboring the boundary. The light amount reducing member 21 is capable of transmitting light and has a greater attenuation coefficient than that of the light guide plate 15.

The light guide plate 15 is in the shape of a wedge. The linear light source 11 is provided along one end side (left-hand end side) of the light guide plate 15. Light emitted by the linear light source 11 is input to the end side (incident side) of the light guide plate 15. Light input to the end side of the light guide plate 15 is propagated through the light guide plate 15 toward the other end side. In this case, light going toward the rear side of the light guide plate 15, on which the reflection sheet 14 is provided, is reflected by the reflection sheet 14 toward the front side of the light guide plate 15, on which the liquid crystal panel 101 is provided. The light is emitted through the front side of the light guide plate 15. A plurality of optical sheets (e.g., the diffuse sheet 16, the condenser sheet 17, and the diffuse sheet 18) are provided at the rear side of the liquid crystal panel 101 so that the liquid crystal panel 101 is uniformly irradiated with light. Note that a lamp cover (not shown) is attached to a predetermined portion of the chassis 13.

The liquid crystal panel 101, on which a circuit board and the like are mounted, is provided on the backlight unit 10. The liquid crystal panel 101 is fixed at a predetermined portion of the chassis 13 via a metal frame 20.

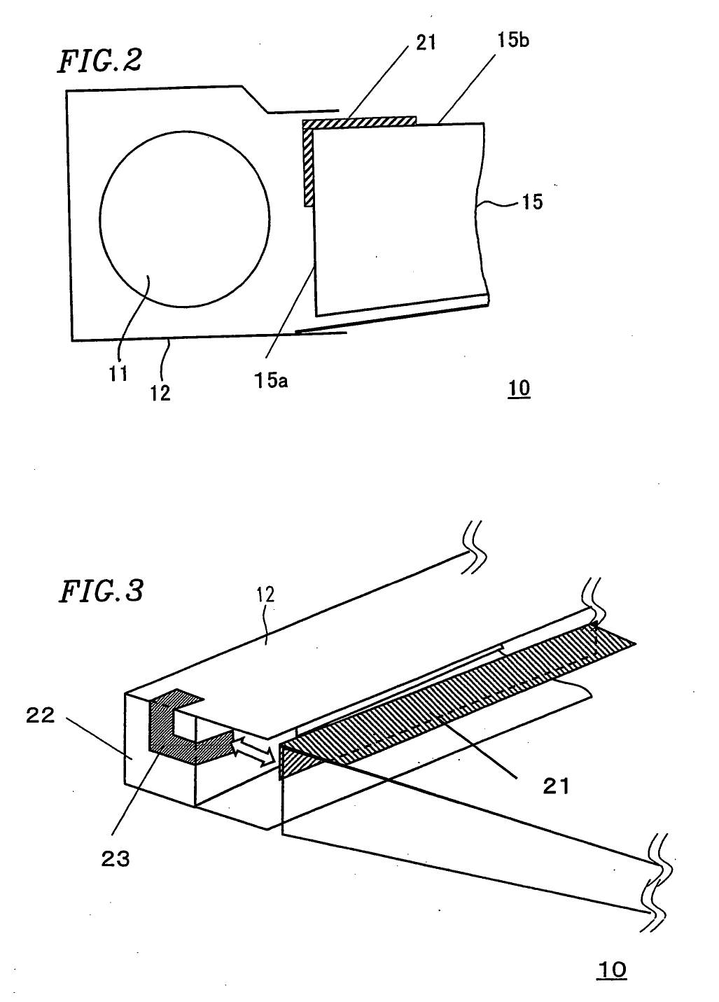

FIG. 2 is a cross-sectional view showing one end portion of the backlight unit 10 of FIG. 1.

The light amount reducing member 21 is provided at an upper edge portion (corner portion) of an end side 15a of the light guide plate 15, which is proximal to the linear light source 11. The light amount reducing member 21 is capable of transmitting light, has a greater attenuation coefficient than that of the light guide plate 15, and has conductivity.

In the embodiment of the present invention, the light amount reducing member 21 extends from the end side 15a to a light emitting side 15b of the light guide plate 15. The cross-section of the light amount reducing members 21 is in the shape of an “L”.

FIG. 3 is a perspective view showing the end side portion of the backlight unit 10. A rubber holder 22 holds the linear light source 11. A conductive sheet 23 is interposed between the rubber holder 22 and the light amount reducing members 21. At least a portion of the conductive sheet 23 is attached to the metal lamp reflector 12 via a conductive adhesive. The lamp reflector 12 is connected (grounded) to GND.

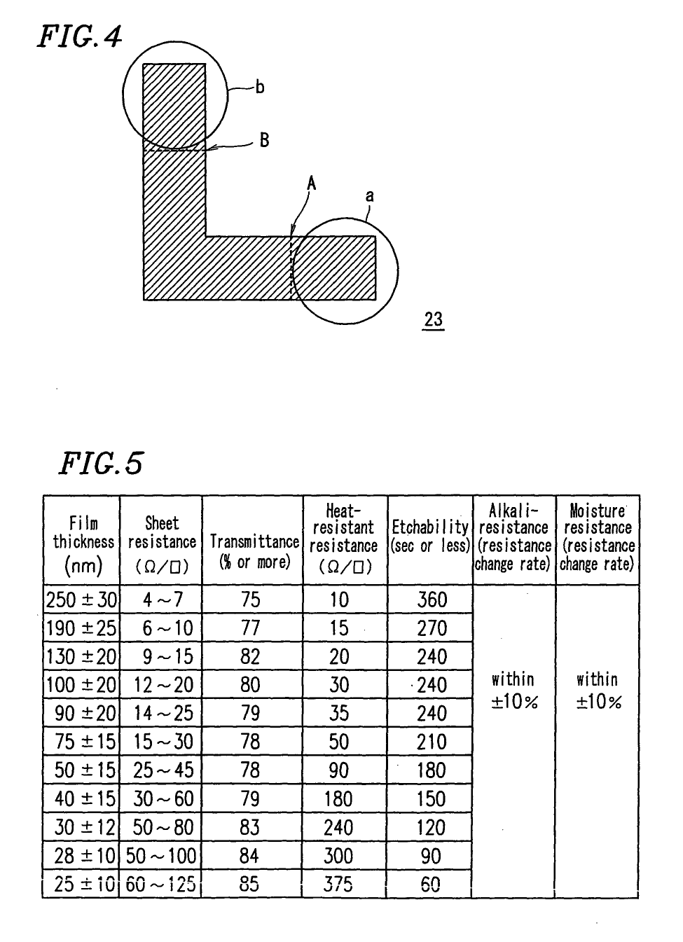

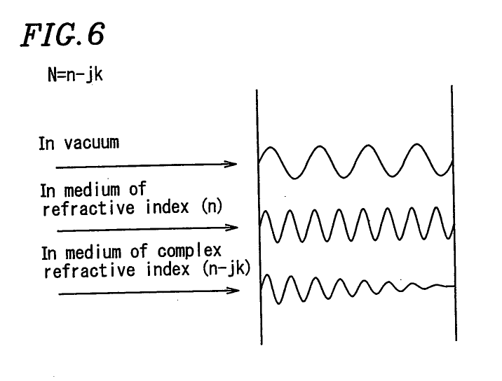

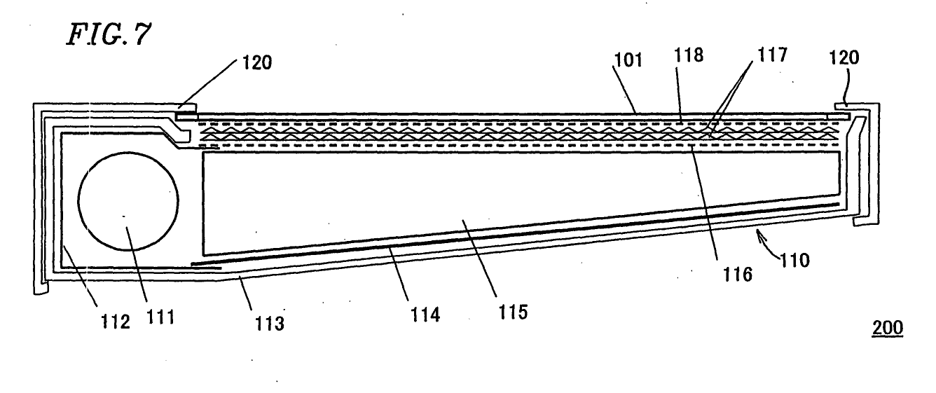

FIG. 4 shows an exemplary development of the conductive sheet 23. The developed conductive sheet 23 is in the shape of an “L”. The right hand end side portion (a) of the developed conductive sheet 23 is connected (or adhered) to the light amount reducing member 21, while the left hand end side portion (b) of the developed conductive sheet 23 is connected (or adhered) to the lamp reflector 12. For example, the upper end side portion (portion b) of the developed conductive sheet 23 is connected to the lamp reflector 12 provided on the top side of the rubber holder 22. Alternatively, the upper end side portion (portion b) of the developed conductive sheet 23 is interposed between the top side of the rubber holder 22 and the lamp reflector 12.

The conductive sheet 23 is folded along dashed lines A and B.

The light amount reducing members 21 is made of a material which is capable of transmitting light, has a greater attenuation coefficient than that of the light guide plate 15, and has conductivity. Examples of such a material include transparent conductive materials, such as ITO, zinc oxide, tin oxide, and the like. When the light amount reducing members 21 is made of such a material, the amount of light which is emitted from the linear light source 11 to the liquid crystal panel 15, is suppressed. Therefore, the occurrence of a bright line can be reduced on the linear light source 11 side of the liquid crystal panel 15.

ITO is most preferable. This is because: (1) ITO has a low resistance and a high conductivity, i.e., is capable of readily absorbing electromagnetic noise, and (2) ITO is transparent but has a large attenuation coefficient, and has a light transmittance of about 70% to 90% in the visible light region.

A method of forming the light amount reducing member 21 (a thin film made of a transparent conductive material) includes sputtering, vapor deposition, a sol-gel technique, and the like. When the lamp reflector 12, the light amount reducing member 21, the light guide plate 15, and the linear light source 11 are assembled (FIGS. 2 and 3), the thickness of the light amount reducing member 21 is reduced as much as possible for an advantageous merit of structure design. Therefore, the light amount reducing member 21 made of a transparent conductive material (e.g., an ITO film) is preferably formed by sputtering or vapor deposition which can form a thin film. Sputtering is most preferable.

FIG. 5 shows exemplary performances of a general ITO film formed by an in-line type sputtering apparatus. In FIG. 5, “transmittance” indicates the light transmittance of the ITO film irradiated with light (λ=550 nm); “heat-resistant resistance” indicates the resistance of the ITO film after holding at 300° C. for 30 min; “etchability” indicates the time required to etch the ITO film with an etchant (H₂O:HCl:HNO₃=1:1:0.16) at 45° C.; “alkali-resistance” indicates the rate of change in resistance before and after holding the ITO film in 1 wt % NaOH aqueous solution at 70° C. for 20 min; “moisture resistance” indicates the rate of change in resistance before and after holding the ITO film in 90% RH at 60° C. for 24 h.

As the thickness of the ITO film is decreased, the sheet resistance, heat-resistant resistance, and transmittance of the ITO film increase (FIG. 5). Further, as the thickness of the ITO film is increased, the etchability of the ITO film decreases (FIG. 5). Furthermore, changes in the alkali-resistance and moisture resistance of the ITO film are suppressed within ±10% irrespective of a change in the thickness of the ITO film (FIG. 5).

The size of the light amount reducing member 21 is determined depending on the arrangement of the linear light source 11 and the lamp reflector 12. The thickness of the light amount reducing member 21 provided on the end side 15a of the light guide plate 15 is preferably about one third of the thickness of the light guide plate 15 at the end side 15a of the light guide plate 15. The thickness of the light amount reducing member 21 provided on the light emitting side 15b of the light guide plate 15 is preferably about 3 mm to 10 mm depending on the level of a bright line occurring at a side of the liquid crystal panel 101, which is proximal to the linear light source 11. The thickness of the light amount reducing member 21 is generally 25 nm to 250 nm, for example, when the light amount reducing member 21 is made of ITO film. The light transmittance of the light amount reducing member 21 varies more or less, depending on the thickness thereof.

As described above, in the backlight unit of the embodiment of the present invention, the light amount reducing member 21 is provided at the end side portion of the light guide plate 15, which is proximal to the linear light source 11 (specifically, a joint portion of the end side and the broader side and portions neighboring the joint portion). The light amount reducing member 21 is capable of transmitting light and is made of a material having a greater attenuation coefficient than that of the light guide plate 15. Therefore, the amount of light which is emitted from the linear light source 11 through the light guide plate 15 to the liquid crystal panel 101 is suppressed. As a result, the occurrence of a bright line at the side of the liquid crystal panel 101, which is proximal to the linear light source 11, is reduced.

The light amount reducing member 21 may be made of a conductive material. By connecting the light amount reducing member 21 made of a conductive material via the conductive sheet 23 and the lamp reflector 12 to a ground, electromagnetic noise occurring from the linear light source 11 (e.g., a fluorescent lamp) is absorbed by the light amount reducing member 21. As a result, the adverse influence of electromagnetic noise on the liquid crystal panel 101 can be reduced.

As described above, in a liquid crystal display apparatus according to the present invention in which a backlight unit irradiates a liquid crystal panel with light for liquid crystal display, a light amount reducing member is provided at an end side portion of a light guide plate, which is proximal to a linear light source (specifically, a joint portion of the end side and the broader side and portions neighboring the joint portion). The light amount reducing member is capable of transmitting light and is made of a material having a greater attenuation coefficient than that of the light guide plate. Therefore, the amount of light which is emitted from the linear light source through the light guide plate to the liquid crystal panel is suppressed. As a result, the occurrence of a bright line at a side of the liquid crystal panel, which is proximal to the linear light source, can be reduced.

Further, by connecting a light amount reducing member made of a conductive material via a conductive sheet and a lamp reflector to a ground, electromagnetic noise occurring from the linear light source (e.g., a fluorescent lamp) is absorbed by the light amount reducing member. As a result, the adverse influence of electromagnetic noise on the liquid crystal panel can be reduced.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A backlight unit, comprising:
a linear light source for generating a light source light;
a light guide plate comprising an end side and a broad side; and
a light amount reducing member for reducing the amount of the light source light, capable of transmitting light and made of a material having a greater attenuation coefficient than that of the light guide plate,
wherein the light source light is input to the end side, is propagated through the light guide plate, and is output through the broad side, and
the light amount reducing member is provided at a joint portion of the end side and the broad side and portions neighboring the joint portion of the light guide plate.

2. A backlight unit according to claim 1, wherein the light amount reducing member is in the shape of an “L” extending from the end side to the broad side.

3. A backlight unit according to claim 1, wherein the light amount reducing member is made of a conductive material.

4. A backlight unit according to claim 1, wherein the light amount reducing member is connected to a ground.

5. A liquid crystal display apparatus, comprising:
a backlight unit, comprising:
a linear light source for generating a light source light;
a light guide plate comprising an end side and a broad side; and
a light amount reducing member for reducing the amount of the light source light, capable of transmitting light and made of a material having a greater attenuation coefficient than that of the light guide plate,
wherein the light source light is input to the end side, is propagated through the light guide plate, and is output through the broad side, and
the light amount reducing member is provided at a joint portion of the end side and the broad side and portions neighboring the joint portion of the light guide plate; and
a liquid crystal panel provided on the broad side of the backlight unit, capable of performing liquid crystal display using the light source light of the backlight unit.
